(19) United States
(12) Patent Application Publication
(10) Pub. No.: US 2026/0056520 A1
(43) Pub. Date: Feb. 26, 2026

(54) AUTOMATED FLAG MANAGEMENT

(71) Applicant: AutoFlag LLC, Boise, ID (US)

(72) Inventors: Keith Philip Sigler, Boise, ID (US); Jacob Holloway, Boise, ID (US); Robert Grover, Boise, ID (US); Kealyb Stephen Draper, Boise, ID (US); Matthew Terry Little, Boise, ID (US)

(21) Appl. No.: 19/354,776

(22) Filed: Oct. 9, 2025

Related U.S. Application Data
(63) Continuation-in-part of application No. 18/815,795, filed on Aug. 26, 2024, now abandoned.

(51) Int. Cl. G05B 15/02

(52) U.S. Cl. CPC G05B 15/02

(57) ABSTRACT

An automated flag management system and associated methods are disclosed. The system includes a flagpole, a flexible line coupled to a flag, and a motorized winch configured to raise and lower the flag by moving the flexible line. A control box houses control electronics, a motor driver, and a power subsystem including a rechargeable battery and a solar charging circuit. The control electronics are configured to receive commands via a communication interface from a mobile application or a flag control server and to execute scheduled or event-based movements, including positioning the flag at half-staff. The mobile application may provide user controls, scheduling, and/or event-based automation, and may synchronize with a remote service to retrieve half-staff directives.

### RELATED APPLICATIONS

This application claims the filing date benefit of U.S. patent application Ser. No. 18/815,795, titled “Automated Flag Management System powered by Solar with Wi-Fi Connectivity and App Controlled” and filed Aug. 26, 2024, which is hereby incorporated by reference in its entirety.

### TECHNICAL FIELD

The disclosure, in various embodiments, relates generally to the field of flag display systems. More specifically, the disclosure relates to systems and methods for positioning a flag on a flagpole.

### BACKGROUND

Flags are widely used to symbolize national identity, organizational affiliation, or ceremonial observance. In the United States, the American flag is a revered symbol of national pride, unity, and respect. Traditionally, the raising and lowering of a flag on a flagpole is performed manually, requiring a person to be physically present at the flagpole to operate halyards (i.e., flexible lines) and/or mechanical winches. This process can be labor-intensive, time-sensitive, and prone to human error, often resulting in delayed or incorrect compliance with official guidelines. Properly displaying and managing the flag in accordance with established state and federal protocols is an important tradition, particularly during or following events when flags should be flown at half-staff to mark periods of mourning, commemorate significant events, or honor the passing of notable individuals. These protocols are integral to honoring historical moments and conveying collective respect.

Directives to fly flags at half-staff are often issued with little advance notice and may require prompt compliance to maintain proper flag etiquette. In practice, ensuring timely adjustment of a flag to half-staff can be challenging, particularly for flagpoles located in remote, unattended, or high-traffic public areas.

Existing automated flagpole systems typically focus on motorized raising and lowering functions controlled by timers, remote switches, or manual activation. However, such systems generally lack the capability to autonomously determine when a flag should be displayed at half-staff based on official announcements, calendar events, or other authoritative sources. As a result, compliance with half-staff protocols still depends on human monitoring and intervention.

### BRIEF SUMMARY

According to some embodiments of the present disclosure, an automated flag management system includes a drive motor, a limit switch a control system, and a communications module. The drive motor is configured to raise and lower a flag on a flagpole by moving a flexible line coupled to the flag. The limit switch is configured to indicate when the flag is at a raised position on the flagpole and when the flag is at a lowered position on the flagpole. The control system is configured to activate the drive motor. The communications module is configured to receive a flag instruction from a remote computing device and from a flag control server.

According to other embodiments, An apparatus for automating a flagpole includes an enclosure at a flagpole, a motor, a winch, control electronics, a communications module, a power subsystem, an input interface, and a computing device. The winch is within the enclosure and is arranged to engage a flexible line. The control electronics includes a microcontroller and a motor driver. The power subsystem includes a battery and a charge controller. The charge controller is configured to receive energy from a solar panel. The input interface is coupled to at least one of a limit switch, a safety stop detector, a current sensor, and a position sensor. The computing device has a memory and a processing device. The memory contains computer-readable instructions directing the processing device to: receive an electronic signal corresponding to a target flag vertical position, compare a current flag vertical position to the target flag vertical position, determine a flag vertical movement direction, and transmit a signal directing the motor to activate, thereby moving the flexible line corresponding to the flag vertical movement direction.

According to other embodiments, a method of operating an automated flag management system includes receiving, at a controller, at least one of a schedule entry, an event indication, and a user command specifying a target flag position, verifying a safety condition based on a signal from at least one of a limit switch, a safety stop detector, a current sensor, and a position sensor, energizing a motor to move a flexible line coupled to a flag, monitoring the flexible line during movement of the flexible line, and stopping the motor upon the flag reaching the target flag position.

### BRIEF DESCRIPTION OF THE DRAWINGS

FIG. 1 is a simplified elevation view of a flagpole having an external halyard and a control box in accordance with embodiments of the present disclosure.

FIG. 2 is a simplified front internal view of a halyard winch mechanism in the control box of FIG. 1.

FIG. 3 is a simplified rear internal view of the control box of FIG. 1.

FIG. 4 is a simplified perspective external view of the control box of FIG. 1.

FIG. 5 is a simplified side view of the control box of FIG. 1.

FIG. 6 is a simplified elevation view of a flagpole having an internal halyard in accordance with embodiments of the present disclosure.

FIG. 7 is a simplified view of a halyard winch mechanism of the flagpole of FIG. 6.

FIG. 8 is a simplified top view of the halyard winch mechanism of FIG. 7.

FIGS. 9A-9C are simplified rear internal views of the halyard winch mechanism of FIG. 7, illustrating a flag raising operation.

FIGS. 10A-10C are simplified rear internal views of the halyard winch mechanism of FIG. 7, illustrating a flag lowering operation.

FIGS. 11A-11D are simplified diagrams of an application interface for commissioning and controlling an automated flag management system in accordance with embodiments of the present disclosure.

FIG. 12 is a simplified block diagram of a computing device for an automated flag management system in accordance with embodiments of the present disclosure.

FIG. 13 is a simplified block diagram of an automated flag management system in accordance with embodiments of the present disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details.

Drawings presented herein are for illustrative purposes only, and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. The drawings are not necessarily to scale.

As used herein, the term “configured” refers to a size, shape, material composition, orientation, and arrangement of one or more of at least one structure and at least one apparatus facilitating operation of one or more of the structure and the apparatus in a pre-determined way.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure. With reference to the figures, a “horizontal” or “lateral” direction may be perpendicular to an indicated “Z” axis, and may be parallel to an indicated “X” axis and/or parallel to an indicated “Y” axis; and a “vertical” or “longitudinal” direction may be parallel to an indicated “Z” axis, may be perpendicular to an indicated “X” axis, and may be perpendicular to an indicated “Y” axis.

As used herein, features (e.g., regions, structures, devices) described as “neighboring” one another means and includes features of the disclosed identity (or identities) that are located most proximate (e.g., closest to) one another. Additional features (e.g., additional regions, additional structures, additional devices) not matching the disclosed identity (or identities) of the “neighboring” features may be disposed between the “neighboring” features. Put another way, the “neighboring” features may be positioned directly adjacent one another, such that no other feature intervenes between the “neighboring” features; or the “neighboring” features may be positioned indirectly adjacent one another, such that at least one feature having an identity other than that associated with at least one of the “neighboring” features is positioned between the “neighboring” features. Accordingly, features described as “vertically neighboring” one another means and includes features of the disclosed identity (or identities) that are located most vertically proximate (e.g., vertically closest to) one another. Moreover, features described as “horizontally neighboring” one another means and includes features of the disclosed identity (or identities) that are located most horizontally proximate (e.g., horizontally closest to) one another.

As used herein, spatially relative terms, such as “beneath,” “below,” “lower,” “bottom,” “over,” “above,” “upper,” “top,” “front,” “rear,” “left,” “right,” and the like, may be used for case of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

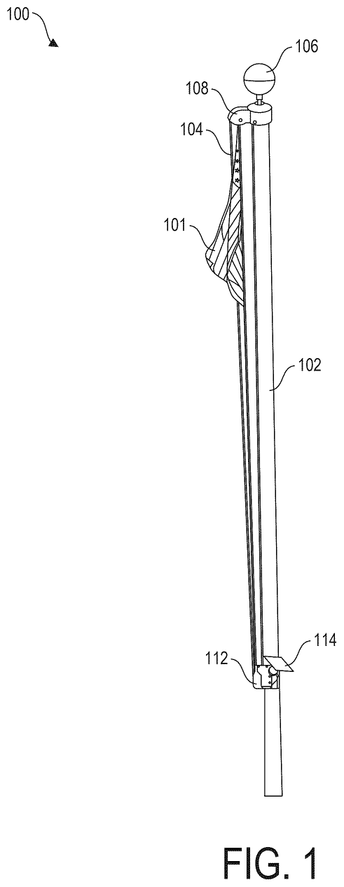

FIG. 1 is a simplified front perspective view illustrating an automated flag management system 100 in accordance with embodiments of the disclosure. In various embodiments, the automated flag management system 100 is configured to raise, lower, and/or position a flag 101 on a flagpole 102 by manipulating a halyard 104 or other type of flexible line (e.g., rope, cable, and the like). These operations may be carried out by controlling the position of the flag 101 according to schedules, real-time commands, and/or event-based rules, including automatic placement at half-staff when appropriate. Embodiments of the automated flag management system 100 comprise various components mounted in or on the flagpole 102, such as the control box 112 as depicted in FIG. 1. However, in other embodiments, one or more of such components may be located away from the flagpole 102. In one embodiment, a control box 112 is mounted on the flagpole 102 near its base.

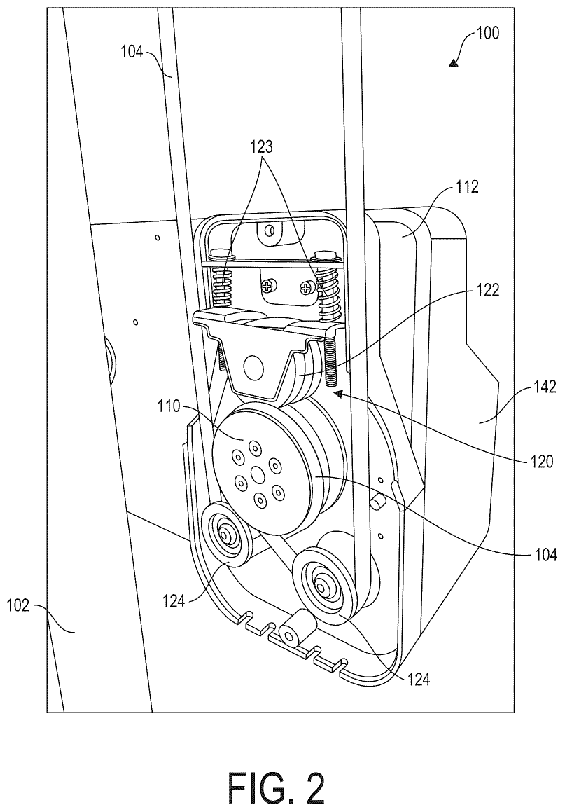

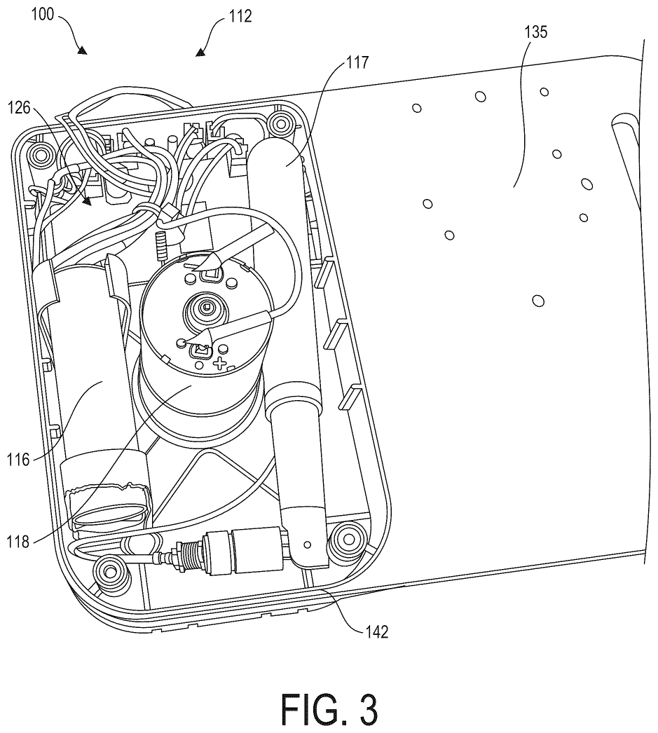

Referring to FIGS. 2 and 3, embodiments of the control box 112 house a drive motor 118, motor pulley 110, control electronics 126, battery pack 116, and antenna 117. According to various embodiments, electrical power to the control box 112 or drive motor 118 may be provided primarily by the solar panel 114 and/or battery 116. The solar panel 114 may generate electrical power from sunlight, which power may be transmitted to a charge controller (not shown), which may then direct electrical power to the battery pack 116 in order to charge it. Electrical power may also be transmitted from the solar panel 114 to a converter (e.g., a DC-to-DC converter) that is configured to convert the voltage of the electrical power to one appropriate to power the drive motor 118, control electronics 126, and/or other electrical components of the automated flag management system 100 during its operation.

In some embodiments, the solar panel 114 is configured to be positioned and/or aimed by a solar panel targeting motor. The solar panel targeting motor may be controlled (e.g., by the control electronics 126) to aim the solar panel 114 toward a current or expected solar position to increase and/or maximize the amount of power generated by the solar panel 114. In one embodiment, the current and/or expected solar position may be determined by taking measurements from a light sensor or the solar panel 114 output as the light sensor and/or solar panels 114 are moved around, noting the direction of maximum light and/or power output. In another embodiment, the current or expected solar position is determined from a table and compared to the current date and/or time. The solar panel 114 may be periodically repositioned to maintain its aim at the sun throughout each day.

In the embodiment depicted in FIGS. 1-5, the halyard 104 is external to the flagpole 102. The halyard 104 is routed in a loop through a pole-top pulley 108. In some embodiments, a pole-top globe/finial 106 is mounted at the top of the flagpole 102 above the pole-top pulley 108. Referring to FIG. 2, FIG. 2 is a simplified view of the embodiment of FIG. 1, showing a relative placement of the control box 112 on the flagpole 102 and the halyard 104 path within the control box 112.

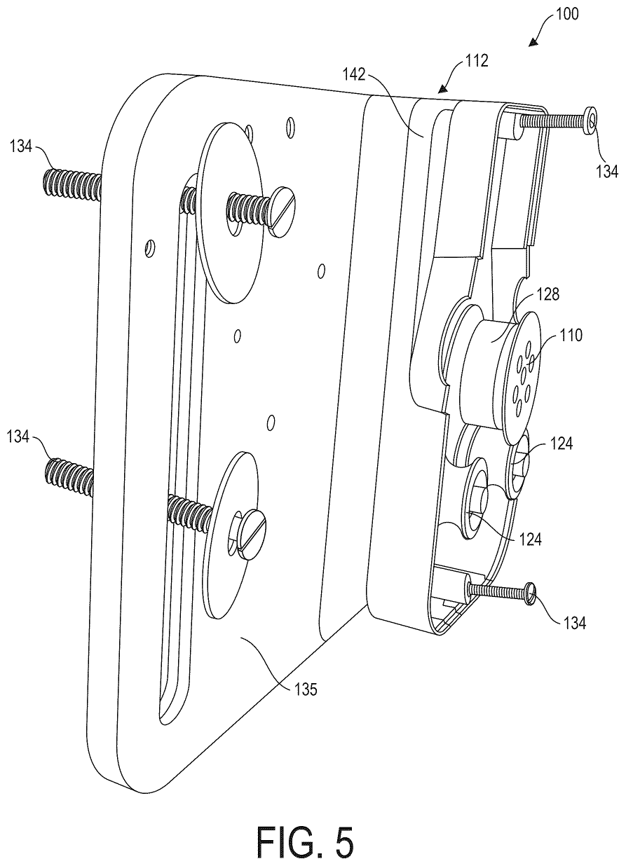

Inside the control box 112, the halyard 104 may wrap around one or more idler wheels 124 and the motor pulley 110, which may be driven by the drive motor 118. In the embodiment depicted, a tensioner assembly 120 comprises a tensioner wheel 122 and one or more tensioner springs 123. The tensioner assembly 120 may be configured to apply force by the tensioner wheel 122 on the halyard 104 against the motor pulley 110 to mitigate and/or reduce slipping as the motor pulley 110 is turning. In various embodiments, the motor pulley 110 has a halyard bearing surface exhibiting increased friction with the halyard 104. In one embodiment, traction tape 128 (FIG. 5) is disposed around the circumference of the motor pulley 110. In some embodiments, a redirect pulley and/or fairlead at the control box 112 may improve the approach angle of the halyard 104 with respect to the idler wheels 124 and/or the motor pulley 110. In some embodiments, upper and/or lower flag position extreme endpoints are defined. In particular, an upper extreme endpoint may be defined as the vertical position of the flag 101 at or near the top of the flagpole 102, while a lower extreme endpoint may be defined as the vertical position of the flag 101 at or near the bottom of the flagpole 102. Embodiments of the present disclosure include limit switches or other types of sensors that can be triggered when a flag 101 reaches such an endpoint. In one embodiment, one or more safety stops are positioned on the halyard 104 such that a limit switch is triggered whenever the flag 101 reaches an upper endpoint and/or a lower endpoint.

In operation, the control electronics 126 can direct the drive motor 118 to be activated, which can rotate the motor pulley 110 and thereby raise or lower the flag 101 by paying out or retrieving the halyard 104. The control electronics 126 may comprise computer readable instructions that direct a desired rotational movement of the drive motor 118, resulting in either raising or lowering the flag 101 on the halyard 104. The wireless module may transmit electronic signals to the control electronics 126, wherein the electronic signals comprise instructions to lower the flag 101, raise the flag 101, and/or set the flag 101 at a specified height. The control electronics 126 can receive and process such electronic signals and direct the drive motor 118 to move the halyard 104 accordingly.

The wireless module is configured to exchange commands and status with a user app and/or a flag control server, which may provide for control of the drive motor 118, and ultimately the position of the flag 101, by one or more users and/or a flag control server. In one embodiment, a user may input commands in a user app (e.g., a software application installed on a smartphone or other personal computing device) to direct the automated flag management system 100 to position the flag 101 at a specified vertical location on the flagpole 102. In some embodiments, the user app may be implemented on a smart home device. As nonlimiting examples, a smart home device may comprise devices known as Amazon Alexa, Google Nest, Apple Homekit, Belkin Wemo, and/or a smart home device manufactured and/or sold under the brands Samsung, LG, Philips, Honeywell, Ecobee, Vivint, ADT, SimpliSafe, Ring, Eufy, Arlo, and Lutron.

As nonlimiting examples, the user may select the position for the flag 101 as “raised,” “lowered,” or “half-staff.” Such a selection may be made via an input object on the user's computing device. The selection may be transmitted to the wireless module (e.g., via direct communication between the user's computing device or via indirect communication through a series of networked computing devices, including the flag control server), which in turn may transmit the selection to the control electronics 126. The control electronics 126 may then activate the drive motor 118 to vertically position the flag 101 on the flagpole 102 as selected.

In other operations, the automated flag management system 100 is configured to move and/or vertically position a flag 101 on a flagpole 102 without user input. In one embodiment, the flag control server may be configured to track occasions and/or schedules when the flag 101 may be raised, lowered, or positioned at half-staff. As a nonlimiting example, the flag control server may be programmed with a calendar of days when it is appropriate to set the flag 101 at half-staff. On such days, the flag control server may transmit an instruction to the control electronics 126 (e.g., via the wireless module) to position the flag 101 at half-staff. As other examples, the flag control server and/or the control electronics 126 may be programmed to raise and lower the flag 101 at one or more programmed times (e.g., the flag 101 may be raised at dawn and/or lowered at dusk).

According to various embodiments, the wireless module may be configured to communicate via any number of wireless protocols. As nonlimiting examples, the wireless module may communicate via cellular data (e.g., LTE or LTE-m), satellite, LoRa, LoRaWAN, Bluetooth, mesh networking, other radio frequency communication methods, other wireless communication methods, or combinations thereof. In one embodiment, the automated flag management system 100 includes a wired communication module instead of, or in addition to, the wireless module. In such an embodiment, the wired communication module may communicate with the flag control server and/or other networked computing devices via any number of wired communication protocols.

FIG. 3 provides a simplified rear view of the control box 112 of FIGS. 1 and 2. As shown in FIG. 3, the control box 112 comprises a device housing 142 having a mounting surface 135 where mounting stand-offs 134 (FIG. 5) or other hardware can fasten the control box 112 to the flagpole 102. As depicted in FIG. 3, the control box 112 can house the control electronics 126, one or more battery packs 116, and an antenna 117. Various embodiments of the control box 112 comprise a collar-mounted design compatible with standard flagpoles.

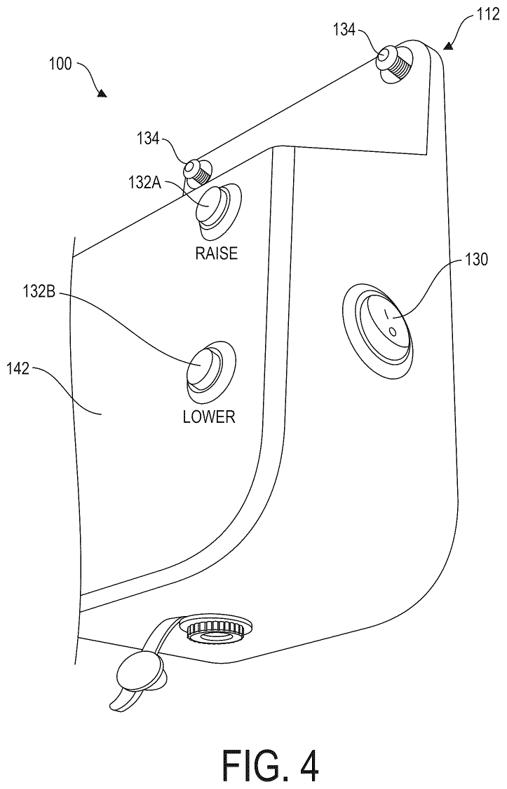

FIG. 4 is a simplified external view of the control box 112 of FIGS. 1-3. As shown, one embodiment includes a power switch 130. Moreover, embodiments of the control box 112 comprise a RAISE command control (e.g., a button) 132A and LOWER command control 132B. FIG. 5 presents a simplified view of the control box 112 of FIGS. 1-4, depicting mounting stand-offs 134 at the mounting surface 135 and within the area of the device housing 142.

In other embodiments of the present disclosure, the automated flag management system 100 may include one or more ambient condition sensors installed near the control box 112 (e.g., on or near the flagpole 102). In various embodiments, the ambient condition sensors may include weather sensors such as a wind sensor, a rain sensor, a barometer, a thermometer, a humidity sensor, and the like. In some embodiments, the ambient condition sensors include a light sensor configured to differentiate between daytime and nighttime. In some embodiments, the automated flag management system 100 comprises a module configured to access weather conditions from a third party weather information provider (e.g., via API calls). According to various embodiments, the control electronics 126 can formulate and/or modify a flag raising and/or lowering schedule according to current ambient conditions. For examples, a user may input a setting to lower the flag whenever the weather is rainy.

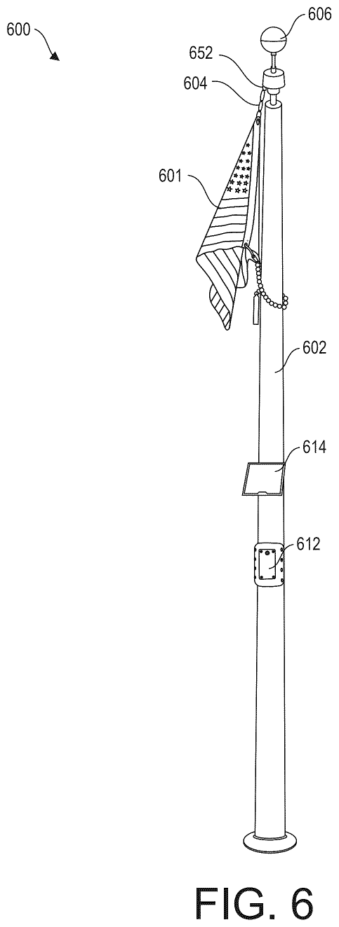

Referring now to FIGS. 6-10, another embodiment of an automated flag management system 600 is depicted according to the present disclosure. In this embodiment, a halyard 604 passes through an internal pole volume of the flagpole 602, routes over a top pulley (e.g., hidden within the flagpole 602 and/or in an internal revolving truck), and exits at a top grommet 652 below a flagpole top (e.g., globe/finial 606). Below the top grommet 652, the halyard 604 can be connected to the flag 601. The control panel cover 612 and solar panel 614 are shown in FIG. 6.

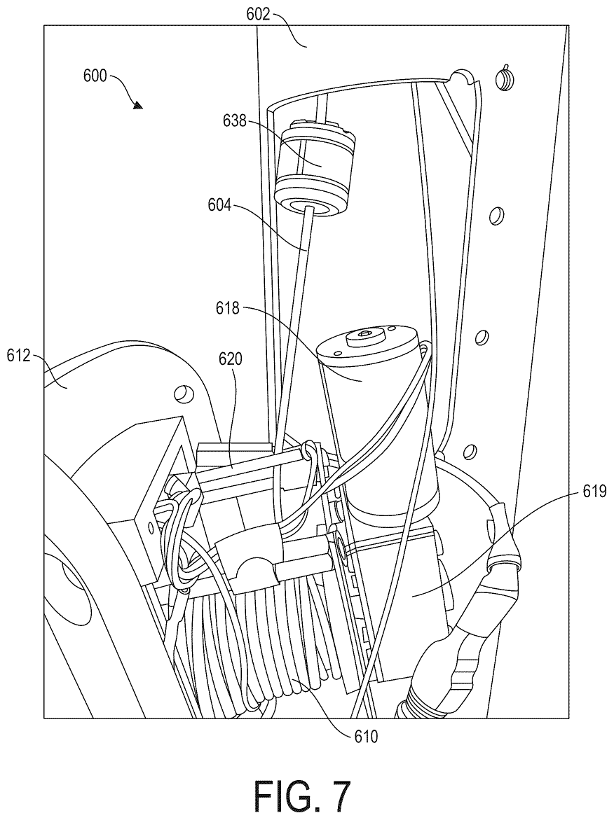

Referring to FIGS. 7-8, various embodiments of the automated flag management system 600 include a drive motor 618, gearbox/reduction stage 619, winch drum 610 and limit switch 620. Various embodiments may further include an antenna, battery pack, and control electronics. As shown in FIG. 8, according to one embodiment of the automated flag management system 600, the limit switch 620 may be positioned at or near the winch drum 610 adjacent to a travel path of the halyard 604 above the winch drum 610. One or more safety stops 638 are affixed to the halyard 604 at vertical positions that correspond to upper and/or lower flag position extreme endpoints, such that the safety stop 638 that corresponds to each respective extreme endpoint contacts the limit switch 620 when the flag 601 reaches that extreme endpoint. The limit switch 620 may be configured to transmit a signal to the control electronics when the halyard 604 reaches a travel limit so that the control electronics can halt movement of the drive motor 618 and stop movement of the halyard 604.

In some embodiments of the present disclosure, a control box or other element may be located partially inside the circumference of a flagpole and partially outside. For example, some embodiments comprise a winch drum 610, or other cylindrical or like mechanism configured to rotate to pay out or retrieve the halyard, which is disposed completely within the horizontal confines of a flagpole. Other embodiments comprise such an object partially outside the horizontal confines of a flagpole and partially inside the horizontal confines of the flagpole. One embodiment comprises a flag automation assembly (e.g., comprising control electronics and a drive motor) configured to be retrofitted to an existing flagpole by partially inserting the assembly into the flagpole, with a housing being anchored on the outside of the flagpole, and part of the flag automation assembly being in the housing exterior to the flagpole.

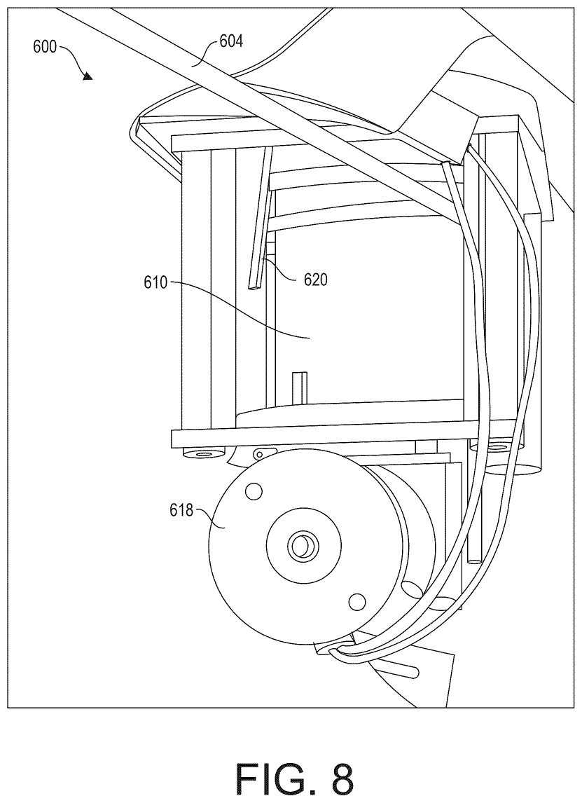

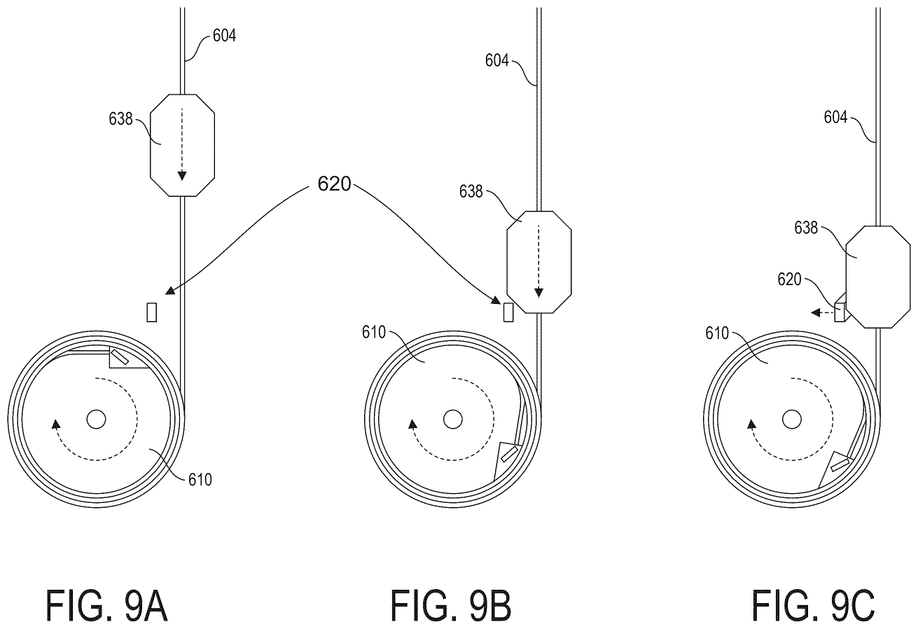

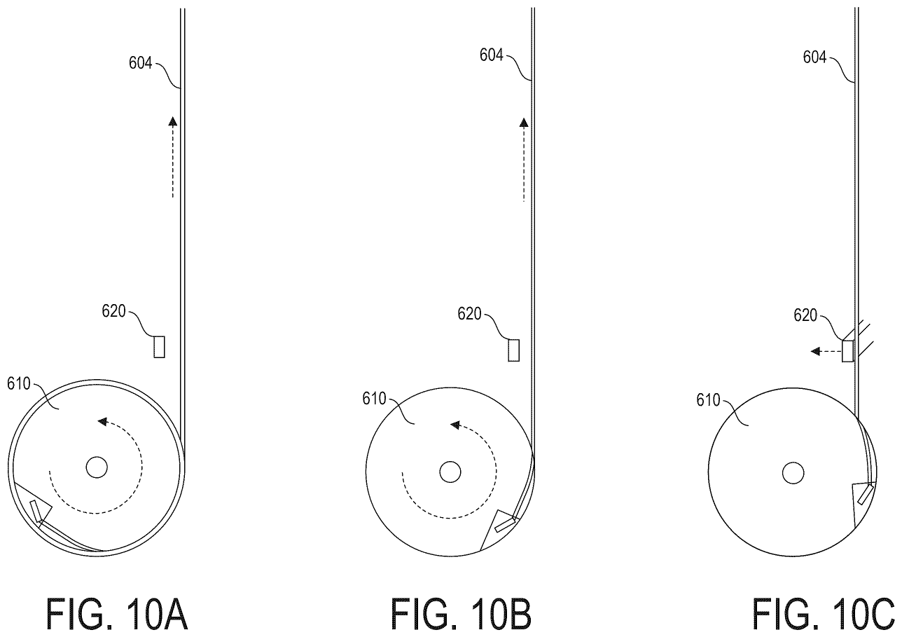

FIGS. 9A-9C illustrate one mode of operation of raising the flag 601 until the limit switch 620 is triggered by the safety stop 638 (FIG. 9C), thereby signaling that the flag has reached its raised position. FIGS. 10A-10C illustrate one mode of operation of lowering the flag 601 until the limit switch 620 is triggered by the halyard 604 (FIG. 10C), thereby signaling that the flag has reached its lowered position. In this manner, the automated flag management system 600 can position a flag 601 at either a raised position or a lowered position. In some embodiments, a flag 601 may be positioned at a point between the extreme upper position and the extreme lower position of the flagpole 602 (i.e., at a half-staff position). In one embodiment, the flag 601 is positioned at a half-staff position by driving the drive motor 618 for a pre-calibrated duration of time (e.g., using a known halyard feed rate and length). In another embodiment, a feed rate sensor is utilized to measure the halyard 604 feed distance as the drive motor 618 moves the halyard 604 to position the flag 601 at half-staff. In some embodiments, an internal guide sheave and/or internal pulley may reduce friction and/or noise inside the flagpole 602.

According to various embodiments of the automated flag management system 100 or the automated flag management system 600, the control box 112 and/or the control panel cover 612 may integrate mounting bosses, weather seals or gaskets, and enclosure fasteners. In certain embodiments, the control box 112 and/or the control panel cover 612 is configured as a retrofit unit for attachment to an existing flagpole 102, 602 without requiring modification of the pole-top hardware. The control box 112 and/or the control panel cover 612 may include integrated mounting brackets or separate bracket assemblies adapted to clamp around the flagpole 102, 602 using band clamps, U-bolts, and/or similar fasteners. The brackets may be dimensioned to accommodate common flagpole 102, 602 diameters and may include protective liners to prevent surface damage. This arrangement may enable the automated flag management system 100 or the automated flag management system 600 to be installed on legacy flagpoles 102, 602 with minimal alteration, thereby preserving the original pole structure while adding motorized and wireless control functionality.

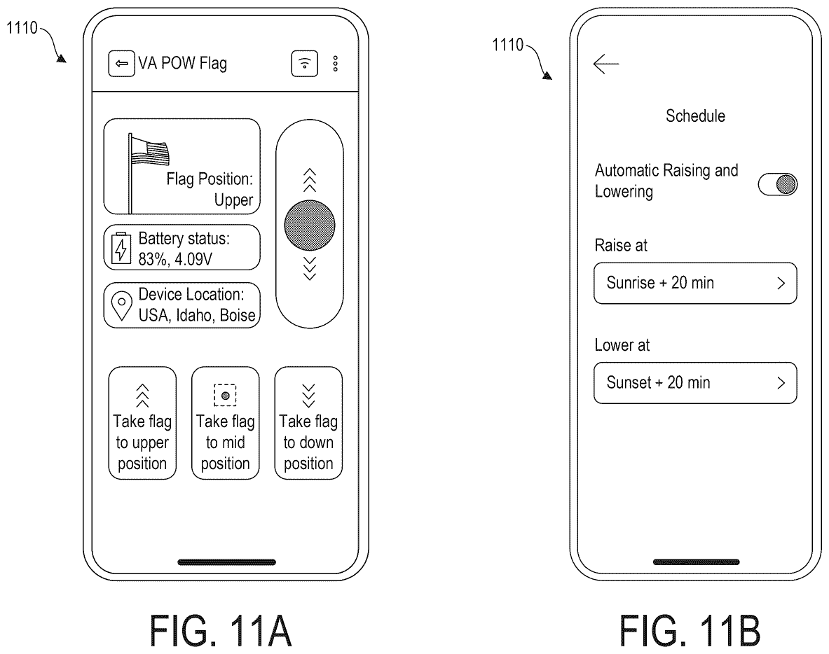

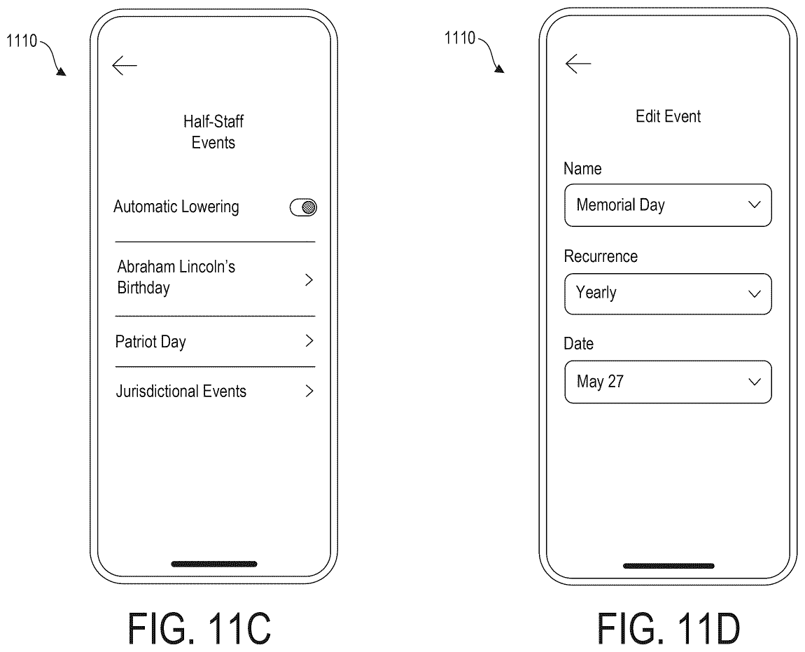

FIGS. 11A-11D illustrate various app interfaces 1100 (e.g., running on a mobile device) for commissioning and controlling the system. The dashboard may present status indicators including current flag position (e.g., raised/half-staff/lowered), battery state of charge/solar input, and connectivity. The interface may provide command objects RAISE, LOWER, and STOP/OVERRIDE, together with a HALF-STAFF mode input object that can be engaged manually or automatically via event-based rules. A schedule may allow time-based automation (e.g., daily raise at sunrise plus/minus a desired offset, lower at sunset, etc.), and a connectivity module supports pairing and network settings for the wireless module. Optionally, the app may synchronize with a cloud service to retrieve authoritative half-staff proclamations or other state and/or federal flag protocols, holiday calendars, geolocation-based sunrise/sunset times, firmware updates, and/or to log usage data for compliance or maintenance reporting.

According to some embodiments of the present disclosure, the dashboard displayed on an app interface 1100 may include information regarding the current status of the flag 101, 601 or other elements of the automated flag management system 100, 600. In one nonlimiting example, the app interface 1100 may display a current vertical position of the flag 101, 601 (e.g., lowered, raised, half-staff). In other examples, the app interface 1100 may display current weather conditions, daylight, and the like. In one embodiment, the app interface 1100 is configured to generate real-time notifications regarding the status and/or positioning of the flag 101, 601. In embodiments, the app interface 1100 may provide educational content about flag protocols (e.g., history about the cause for flying the flag 101, 601 at half-staff, biographical information about a person being honored).

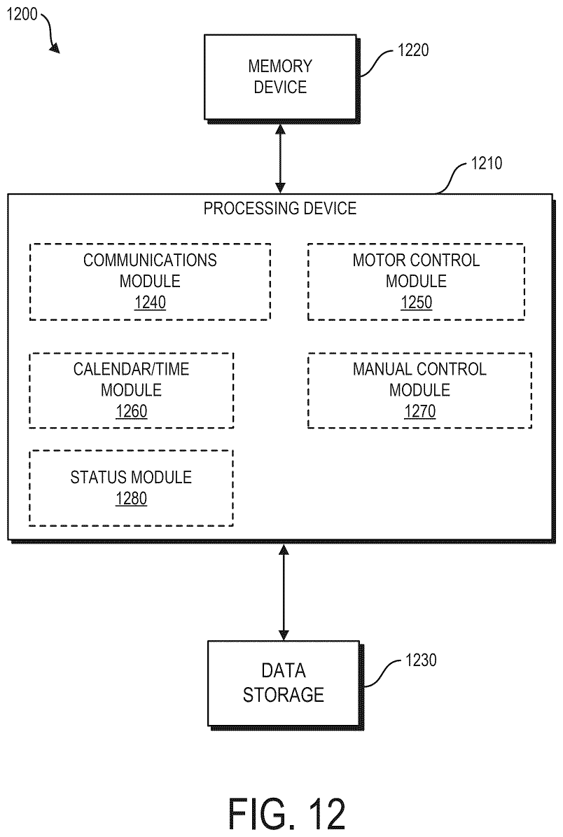

FIG. 12 illustrates a simplified block diagram of an automated flag management computing device 1200 (e.g., control electronics 126) according to various embodiments of the present disclosure. An automated flag management computing device 1200 comprises a processing device 1210, memory device 1220, and data storage 1230. In the embodiment depicted, the processing device 1210 comprises communications module 1240, motor control module 1250, calendar/time module 1260, manual control module 1270, and status module 1280. In various embodiments, communications module 1240, motor control module 1250, calendar/time module 1260, manual control module 1270, and/or status module 1280 individually comprise computer readable instructions that direct the processing device 1210 to carry out specific operations.

The communications module 1240 may include computer readable instructions that direct the automated flag management computing device 1200 to send and/or receive data and/or instructions to and/or from another computing device. The instructions and/or data may relate to operation of and automated flag management. As a nonlimiting example, the instructions may include instructions to raise, lower, and/or set at half-staff a flag. As further nonlimiting examples, the data may relate to calendar dates and/or to times on which the flag will be positioned at a raised, lowered, and/or a half-staff position.

The motor control module 1250 may include computer readable instructions that direct the automated flag management computing device 1200 to activate its drive motor (e.g., drive motor 118, 618) to move a flag to a particular position (e.g., raised, lowered, half-staff). The drive motor may thus be driven for a specific duration, or according to other parameters, such as until a limit switch (e.g., limit switch 620) is triggered.

The calendar/time module 1260 may include computer readable instructions that direct the automated flag management computing device 1200 to track the current date, and compare the current date against a table of days designated to fly the flag at half-staff. Such a table may be stored at data storage 1230. When the current date matches a designated date, the calendar/time module 1260 may be configured to transmit an instruction to the motor control module 1250 to position the flag at half-staff. Further, embodiments of the calendar/time module 1260 may include computer readable instructions that direct the automated flag management computing device 1200 to track the current time, and upon reaching a designated flag-raising time, transmit an instruction to the motor control module 1250 to raise or lower the flag accordingly.

The manual control module 1270 may include computer readable instructions that direct the automated flag management computing device 1200 to raise or lower the flag according to manual inputs (e.g., inputs made at the RAISE command control 132A or the LOWER command control 132B). In one example, a user may activate a manual input to raise or lower the flag (e.g., by pressing the corresponding button on the control box 112), in which case the manual control module 1270 may direct the automated flag management computing device 1200 to activate the motor control module 1250 to raise or lower the flag according to the input. In some embodiments, the user may enter the automated flag management system into a maintenance mode that temporarily disables automated flag movement functions so that the user may input manual flag positioning instructions as described above.

The status module 1280 may include computer readable instructions that direct the automated flag management computing device 1200 to receive, interpret, and store status data related to the operational status of the automated flag management system. Such status data may be stored at the memory device 1220 and/or data storage 1230. The status data may be gathered from one or more sensors in the automated flag management system, and may include, as nonlimiting examples, the flag vertical position, voltage level(s) in one or more batteries, solar power generation levels, signal strength levels, motor activation events, ambient conditions, and other information related to the functioning of the automated flag management system. The status module 1280 may be further configured to transmit such information to the flag control server and/or user app for storage, display, and/or further processing.

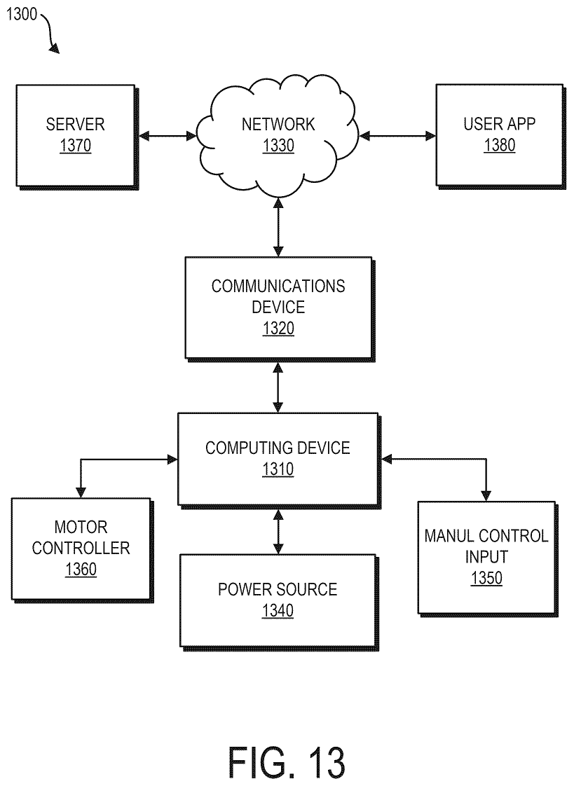

FIG. 13 illustrates a simplified block diagram of an automated flag management system 1300 (e.g., automated flag management system 100, 600) according to various embodiments of the present disclosure. In one embodiment, the automated flag management system 1300 comprises a computing device 1310, a communications device 1320, a network 1330, a power source 1340, a manual control input 1350, a motor controller 1360, a server 1370, and a user app 1380.

In some embodiments of the present disclosure, the computing device 1310 comprises control electronics (e.g., control electronics 126, automated flag management computing device 1200). In one embodiment, the computing device 1310 comprises a microcontroller comprising a processor and a memory, the memory containing computer-readable instructions that direct the processor to carry out the various functions described in this disclosure.

In some embodiments of the present disclosure, the communications device 1320 comprises a communications module configured to transmit and/or receive signals via one or more wired and/or wireless networks 1330 (e.g., cellular, Wi-Fi, BLE, other types of networks, or combinations thereof). The communications device 1320 may comprise one or more antennas (e.g., antenna 117).

In some embodiments of the present disclosure, the power source 1340 comprises various combinations of one or more batteries, one or more battery monitors, one or more voltage converters, one or more solar panels, and the like. One embodiment of the present disclosure receives electrical power from the power grid. Other embodiments are powered by one or more solar panels. In some embodiments, the power source 1340 comprises a backup battery or other power source.

In some embodiments of the present disclosure, the manual control input 1350 comprises manual inputs (e.g., the RAISE command control 132A or the LOWER command control 132B) by which a user may manually control positioning of the flag as described above with respect to the manual control module 1270. In some embodiments of the present disclosure, the motor controller 1360 may receive an instruction from the computing device 1310 to raise or lower the flag. The motor controller may thus energize a drive motor (e.g., drive motor 118, 618) to turn in a rotational direction that corresponds to the indicated flag direction of movement (e.g., up or down). The motor controller may receive a stop signal when a limit switch (e.g., limit switch 620) is triggered, after a predetermined duration, when a specific halyard length has been drawn, and/or when the motor controller 1360 or other module determines that the flag has reached an intended vertical position.

In some embodiments, the server 1370 (e.g., a flag control server) may receive and/or transmit instructions and/or data to and from the communications device 1320 by way of one or more networks 1330. Further, the server 1370 may receive and/or transmit instructions and/or data to and from the user app 1380. These instructions and data may relate to operating parameters for the automated flag management system 1300. As a nonlimiting example, the server may transmit a manual flag positioning instruction to the communications device 1320, which may then transmit the same instruction to the computing device 1310, which may then store the instruction and/or take action on the instruction. The instruction may comprise a command to raise or lower the flag or position the flag at half-staff. As another nonlimiting example, the server 1370 may transmit a table of dates for the flag to be flown at half-staff. As another nonlimiting example, the server 1370 may transmit a dawn/dusk schedule so the computing device 1310 may direct raising and/or lowering of the flag at desired time(s).

In some embodiments, the user app 1380 may comprise software and data installed on a user's personal computing device (e.g., a smartphone, a smart home device). The user app 1380 may provide for provisioning and/or direct control of the automated flag management system 1300 as described above with respect to FIGS. 11A-11D.

In various embodiments of automated flag management systems (e.g., automated flag management system 100, 600, 1300), half-staff directives may be acquired from any number of sources and input by manual and/or automated means. In some embodiments, a large language model (LLM) and/or other artificial intelligence (AI) module is configured to extrapolate and/or normalize data from heterogeneous or unstructured sources (e.g., proclamations, emails, videos, social posts), extract structured half-staff events, resolve conflicts, map individual events to relevant jurisdictions, and/or trigger push notifications and/or automated flag lowering/raising directives to servers, smartphone devices, and/or other flag automation computing devices (e.g., control electronics 126, automated flag management computing device 1200, computing device 1310). Such notifications and/or directives may include an explanatory reason for the directive. Embodiments may include a policy engine configured to resolve conflicting directives, detect and/or applying rescissions, and/or evaluate applicability to specific flag installations using jurisdiction mapping and geofencing. In embodiments, the LLM may be installed on a device (e.g., control electronics 126, automated flag management computing device 1200, server computing device 1310, user app 1380, server 1370) or on a cloud (i.e., remote) server.

Embodiments of the present disclosure may include various operations to validate and/or provide provenance of half-staff events acquired by an LLM and/or other AI module. In some examples, the push notification includes contextual or provenance information about the source material used to generate the half-staff event. In some cases, a half-staff event may be classified as a low-confidence event. Such events may be routed to a human-in-the-loop review queue for manual verification.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalents. For example, elements and features disclosed in relation to embodiments of the disclosure may be combined with elements and features disclosed in relation to other embodiments of the disclosure.

What is claimed is:

1. An automated flag management system, comprising:
a drive motor configured to raise and lower a flag on a flagpole by moving a flexible line coupled to the flag;
a limit switch configured to indicate when the flag is at a raised position on the flagpole and when the flag is at a lowered position on the flagpole;
a control system configured to activate the drive motor; and
a communications module configured to receive a flag instruction from a remote computing device and from a flag control server.

2. The automated flag management system of claim 1, further comprising a mechanical safety stop affixed to the flexible line and configured to contact the limit switch when the flag is at a raised position on the flagpole or when the flag is at a lowered position on the flagpole.

3. The automated flag management system of claim 2, wherein the mechanical safety stop is configured to contact the limit switch upon:
the flag reaching the raised position on the flagpole or
the flag reaching the lowered position on the flagpole.

4. The automated flag management system of claim 1, further comprising a power subsystem including at least one of a solar panel, a battery, and a charge controller.

5. The automated flag management system of claim 4, wherein the solar panel is positioned to aim at a solar position.

6. The automated flag management system of claim 1, further comprising a status module configured to transmit status data comprising at least battery state of charge, connectivity, and flag position to the flag control server.

7. The automated flag management system of claim 1, wherein the flag instruction comprises a directive to: raise the flag to the raised position on the flagpole, lower the flag to the lowered position on the flagpole, or position the flag at a half-staff position on the flagpole.

8. The automated flag management system of claim 1, wherein the flagpole has a location, and the control system is configured to compute a sunrise and a sunset time at the location of the flagpole.

9. The automated flag management system of claim 1, wherein the communications module is configured to transmit a signal over at least one of: a cellular radio, a Wi-Fi interface, and a Bluetooth interface.

10. The automated flag management system of claim 1, further comprising a tamper-resistant and weather-resistant enclosure.

11. The automated flag management system of claim 1, wherein the communications module is configured to receive near real-time information related to an event.

12. The automated flag management system of claim 1, further comprising a computing device comprising a memory and a processing device, the memory containing computer-readable instructions directing the processing device to:
extrapolate data from communications from at least two distinct sources selected from executive proclamations, emails, and social-media posts;
use a large language model or other artificial intelligence module to extract, from the communications, structured half-staff event data comprising an effective start time, an end time, a jurisdiction, and a reason;
resolve conflicts among the communications referring to a same event by applying source-priority and confidence-scoring rules;
determine applicability of the structured half-staff event data to an installation of the automated flag management system based on a jurisdiction; and
cause a user device to output a push notification including the reason and an indication to reposition the flag.

13. The automated flag management system of claim 12, wherein the memory contains additional computer-readable instructions directing the processing device to:
use the large language model or other artificial intelligence module to generate a flag movement command; and
automatically apply the flag movement command to a motor controller.

14. An apparatus for automating a flagpole, comprising:
an enclosure at a flagpole;
a motor;
a winch within the enclosure and arranged to engage a flexible line;
control electronics including a microcontroller and a motor driver;
a communications module;
a power subsystem including a battery and a charge controller configured to receive energy from a solar panel;
an input interface coupled to at least one of a limit switch, a safety stop detector, a current sensor, and a position sensor; and
a computing device comprising a memory and a processing device, the memory containing computer-readable instructions directing the processing device to:
receive an electronic signal corresponding to a target flag vertical position;
compare a current flag vertical position to the target flag vertical position;
determine a flag vertical movement direction; and
transmit a signal directing the motor to activate, thereby moving the flexible line corresponding to the flag vertical movement direction.

15. The apparatus for automating a flagpole of claim 14, further comprising a mechanical safety stop affixed to the flexible line and configured to contact the limit switch when the flag is at a raised position on the flagpole or when the flag is at a lowered position on the flagpole.

16. The apparatus for automating a flagpole of claim 14, further comprising a computing device comprising a memory and a processing device, the memory containing computer-readable instructions directing the processing device to:
extrapolate data from communications from at least two distinct sources selected from executive proclamations, emails, and social-media posts;
use a large language model or other artificial intelligence module to extract, from the communications, structured half-staff event data comprising an effective start time, an end time, a jurisdiction, and a reason;
resolve conflicts among the communications referring to a same event by applying source-priority and confidence-scoring rules;
determine applicability of the structured half-staff event data to an installation of the apparatus for automating a flagpole based on a jurisdiction; and
cause a user device to output a push notification including the reason and an indication to reposition a flag.

17. A method of operating an automated flag management system, comprising:
receiving, at a controller, at least one of a schedule entry, an event indication, and a user command specifying a target flag position;
verifying a safety condition based on a signal from at least one of a limit switch, a safety stop detector, a current sensor, and a position sensor;
energizing a motor to move a flexible line coupled to a flag;
monitoring the flexible line during movement of the flexible line; and
stopping the motor upon the flag reaching the target flag position.

18. The method of claim 17, wherein the target flag position comprises a half-staff position determined from a calibration of a flexible line displacement relative to flag elevation.

19. The method of claim 17, further comprising:
extrapolating data from communications from at least two distinct sources selected from executive proclamations, emails, and social-media posts;
using a large language model or other artificial intelligence module to extract, from the communications, structured half-staff event data comprising an effective start time, an end time, a jurisdiction, and a reason;
resolving conflicts among the communications referring to a same event by applying source-priority and confidence-scoring rules;
determining applicability of the structured half-staff event data to an installation of the automated flag management system based on a jurisdiction; and
causing a user device to output a push notification including the reason and an indication to reposition the flag.

20. The method of claim 19, further comprising routing a low-confidence event to a human-in-the-loop review queue.
